(19) United States
(12) Patent Application Publication
(10) Pub. No.: US 2008/0021756 A1
(43) Pub. Date: Jan. 24, 2008

(54) Integrated supply chain business model and website for free auto rental

(76) Inventor: Partha Kesavan, Williamsville, NY (US)

Correspondence Address: Vincent G. LoTempio, P O Box 820, East Amherst, NY, 14051, US

(21) Appl. No.: 11/827,632

(22) Filed: Jul. 12, 2007

Related U.S. Application Data
(60) Provisional application No. 60/830,217, filed on Jul. 12, 2006.

(51) Int. Cl. G06Q 90/00

(52) U.S. Cl. 705/8

(57) ABSTRACT

A vehicle transportation system, comprising the gathering of information consisting of vehicle availability and vehicle destination from a vehicle supplier interested in transporting vehicles from a first location to a second location and storing the vehicle availability information and said vehicle destination information into a centralized computer. An integrated framework programmed to match a vehicle with travelers and passengers to drive or be transported by the vehicle from the first location to the second location and making the vehicle availability information and vehicle destination information accessible via web page on the internet. A “supply chain” model to optimize the distance traveled, the number of vehicle and driver/traveler change overs and the time spent in between change overs and centralized auto terminals to allow for vehicle and driver exchanges.

This application claims priority of U.S. Provisional Patent Application Ser. No. 60/830217 for Integrated Supply Chain Business Model & Website for Free Auto Rental, filed on Jul. 12, 2007.

### BACKGROUND OF THE INVENTION

The present invention relates to a business model and web site where customers can search for automobiles to drive from one location to another without incurring daily rental charges for the vehicle. Such vehicles can be obtained from automobile suppliers such as drive away companies, auto dealerships, auto rentals, other companies or individuals interested in transporting the automobiles from one location to another. The web site provides automobile suppliers an integrated framework to utilize the needs of the companies in a synergistic manner to increase the probability of finding a qualified driver.

Every year people spend more than 19 billion dollars on automobile rentals for travel. In addition to round-trip auto rentals, one-way rentals are also on the rise. For one-way car rentals, typically renters incur additional charges due to increased rental fee or drop-off charge. The present invention provides free auto rentals to appeal to these travelers in terms of saving money spent on car rental.

Various types of methods of automobile sharing have been invented to help a person obtain transportation. Many prior attempts have been made to alleviate the problems associated with these methods. For example, United States Patent Application No. 2004/0024621 to Read, is directed to a business method where a person can apply for a vehicle at a central location, the system checks for accessibility and availability in real-time. The invention is drawn to a method and apparatus for enabling authorized users to share a plurality of vehicles located at numerous locations throughout an urban setting. The system may include a number of vehicles, a number of checkout locations employing different technology according to specific geographic features of the location and a central computer system operatively coupled to the checkout locations and the vehicles at these locations which actively monitors the use of the vehicles in real-time. The system also includes demand predicting software operatively coupled to the central computer and the checkout locations to determine vehicle accessibility and availability. The goal is to build a system capable of matching the private vehicle's high availability ratio of apparently ninety-nine percent or greater. This invention uses a centralized software system which monitors the movement of vehicles and matches drivers with vehicles that are closely geographically located rather than long trips and does not overcome the problem of being able to match drivers and cars and like industries to affect a synergistic relationship.

The U.S. patent application Ser. No. 6,850,153 of Murakami et.al teaches a shared vehicle system that includes a central facility, at least one vehicle distribution port facility and a plurality or fleet of vehicles, each having a vehicle subsystem. In general, the central station and port facility and the vehicle subsystems communicate in a manner to allow a user to enter information at a port facility. That information is then communicated to the central facility, where the information is processed to select a vehicle from the fleet to allocate to the user at the port facility. Selection of a vehicle for allocation to a user may be based on selecting an available or soon to be available vehicle according to various algorithms that take into account the vehicles state of charge. The central station also communicates with the port facility and the vehicle subsystem to notify the user of the selected vehicle, to provide secure user access to the selected vehicle, to monitor the location and operating status of vehicles in the fleet, to monitor the state of charge of electric vehicles and to provide other functions. The vehicles communicate with the central station to notify the central station of the PIN number of the individual attempting to use the vehicle, and of vehicle parameters such as state of charge and location of the vehicle. Again this business method patent application is directed towards methods of sharing a fleet of vehicles for day-to-day urban use and is not directed towards long-distance movement of vehicles and does not overcome the problem of being able to match drivers and cars and like industries to affect a synergistic relationship.

Thus it is readily apparent that there is a longfelt need for a business model along with associated web site for users interested in obtaining automobiles for one way, round trip or multiple destination travel.

### SUMMARY OF THE INVENTION

The present invention is a fundamental business model and web site to bring together individuals and companies needing to transport vehicles, travelers looking for a bargain deal for their travel and to direct them to hotels to increase occupancy.

It is a general object of the present invention to provide a business model that matches automobile companies with travelers for the purpose of transporting people and cars.

Another object of the present invention is to provide an integrated web page linking up all drive away companies, auto rentals, car dealerships, hotels with private vehicle owners interested in moving/driving.

Yet another object of the present invention is to provide access to several drivers using a centralized web site, to increase the probability of finding qualified drivers by operating in a synergistic fashion.

Still another object of the present invention is to provide a Centralized Auto Terminal (CAT) to create stop or change over locations at strategic cities in order to facilitate the movement of vehicle between several start and destination locations.

Another object of the present invention is to provide a common platform for people to share a paid transportation service such as a taxi, car rental, etc. by communicating with each other through the web site.

A further object of the present invention is to provide a method for web site that includes four components: user interface (UI) screens, supply chain model, database to hold all information regarding customer, vehicle availability, etc. and a back ground model and supply chain type optimization search program to match the customer requirement and vehicle availability.

These and other objects, features, and advantages of the present invention will become apparent upon a reading of the detailed description and claims in view of the several drawing figures.

### BRIEF DESCRIPTION OF THE DRAWINGS

FIG. 1 is a schematic diagram of different components involved in creating an integrated web site of the present invention.

FIG. 2 depicts a sample start screen for user interface.

FIG. 3 depicts a sample search screen for registered user of a preferred embodiment of the present invention.

FIG. 4 depicts a schematic showing the functionality of Auto Acceptance Alert system.

FIG. 5 shows a schematic of the Centralized Auto Terminal (CATs) as part of a distribution network.

FIG. 6 depicts a flow chart showing the operation of background optimization program.

FIG. 7 Flow chart for vehicle status change during the course of booking and vehicle transportation.

### DETAILED DESCRIPTION OF THE PREFERRED EMBODIMENT

This application claims priority of U.S. Provisional Patent Application Ser. No. 60/830217 for Integrated Supply Chain Business Model & Website for Free Auto Rental, filed on Jul. 12, 2007. No new matter has been added.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

The present invention relates to a business model and web site where customers can search for automobiles to drive from one location to another without incurring daily rental charges for the vehicle. Such vehicles can be obtained from automobile suppliers such as drive away companies, auto dealerships, auto rentals, other companies or individuals interested in transporting the automobiles from one location to another. The web site provides automobile suppliers an integrated framework to utilize the needs of the companies and/or individuals in a synergistic manner to increase the probability of finding a qualified driver.

Increasing number of travelers prefer to have the flexibility to combine different modes of transportation. For example, people would prefer to travel by car one-way and return by other mode of transportation such as air travel in order to maximize their utility of leisure time by visiting many places in the least time spent. If cost is not the criterion, many people would also prefer to have 2 one-way car rentals instead of a round-trip rental if the stay at destination is going to be extended (a week or more). This would save the traveler the rental charge incurred during their stay at the destination (if they have other modes of transportation at the destination).

Many people such as those relocating from one location to another, snow birders (people who migrate from north to south during winter and vice versa during summer), parents who want to send their old cars to their kids, adventurous travelers, people winning automobile prizes from a non home town location, bikers, etc. transport their automobile using drive away companies or individual contracted drivers. Rental cars and RV rental organizations also look for qualified drivers to transport their vehicles to meet increased seasonal demands in different locations. Fortune 500 companies typically use drive away companies to transport their fleet of vehicles (or to move their employees) from one location to another. More than 20,000 cars annually are transported nationally using drive away companies. Drive away companies save people lots of money by employing qualified drivers to drive and move people's automobile from one location to another. Currently, the drive away companies are scattered and operate in an independent uncoordinated fashion. It is very difficult for both the people who need their automobiles to be moved and people who are looking to move automobiles to find each other using such uncoordinated drive away companies. The web site of the instant invention aims to provide an integrated way to connect all drive away companies, car rentals as well as individuals interested in moving/driving. The result is saving time and money for all parties involved.

The automobile suppliers, in addition to having access to several drivers using a centralized web site, can increase the probability of finding qualified drivers by operating in a synergistic fashion. Instead of looking for a single driver to go the entire way from the origin to destination, integrated software of the business model of the present invention takes into account intermediate stop over points where either the automobile or the driver can be switched over. For example, if a company has a vehicle to be moved from New York to Orlando and a single driver is not available to take this trip but a driver is available to go from New York to Charlotte and another driver is available to go from Charlotte to Orlando the program will consider Charlotte as an intermediate point for switch over and coordinate the two drivers to transfer the vehicle from New York to Orlando. On the flip side if two different automobile companies have vehicles to be transported, one from New York to Charlotte and one from Charlotte to Orlando instead of assigning two people to move two vehicles, the program will coordinate the movement of one person to move both cars. Thus, the business model provides a framework for car companies to operate in a synergistic manner and mutually benefit from each other.

The automobile transportation concept will be extended to car dealerships. Car dealerships in multiple cities usually obtain cars from nearby city locations (usually within 100 to 200 miles) to meet customer needs. They use one of their staff members or hire a person or truck to move such vehicles. These dealerships will be integrated to get access within the web site to drivers with excellent driving records able to drive these vehicles as part of their travel. This will save the car dealerships several thousand dollars in terms of lost work time, transportation costs, etc.

The preferred embodiment of the present invention is a methodology and a business model that matches automobile companies with travelers and thereby improve the probability of finding each other. In addition, the business model also provides a framework for auto suppliers and travelers to work synergistically with hotel companies by using the concept of “Centralized Auto Terminals.” The Centralized Auto Terminal is a stop or change over locations at strategic cities in order to facilitate the movement of vehicle between several start and destination locations.

Information consisting of automobile availability from several drive away companies, auto dealerships, auto rentals, other companies or individuals interested in transporting automobiles from one location to another is gathered, stored and is accessed at a centralized web site. Users/customers can access the centralized web site and search for automobiles to drive from one location to another without incurring daily rental charges or drop-off charges for the vehicle (as would be the case if the traveler rents from a traditional auto rental company). Each customer is provided with the option to search for vehicles over a date and distance range. A “supply chain” model optimizes the distance traveled, the number of automobile change over and the time spent in between change over in order to provide the best optimization for the customer. The software for the centralized web site searches for a change of automobiles and a stop over in different cities, if an automobile is unavailable for direct rental between the specified cities. The automobiles from different cities may be from the same company of original rental or may involve more than one company. The web site also serves as a common platform where people with common interest with respect to source and destination will be able to contact each other to share a paid transportation. For example, people can use this site to find other people to share a taxi ride from Airport to a particular location, share a rental car in a tourist location, etc.

A supply chain type model links the automobile suppliers at several locations. The supply chain model utilizes the information provided by the automobile suppliers to relate several start and destination locations along with possible intermediate locations. The intermediate locations are obtained from information entered by the supplier (using the supplier's page) or by using the Centralized Auto Terminals (CAT). The overall model uses a standardized distance chart available from a reputable public domain (such as Mapquest, etc.) to relate different locations origin/destination locations with the intermediate locations. The supply chain models also have all the necessary information about the intermediate locations (such as hours of operation, size of location, average number of automobiles available in the location, etc.) The CATs are located at several locations. Optimal locations will be determined by the vehicle transportation logistics. In addition, these CATs may be independently owned and operated or owned by a consortium of automobile transportation companies. The CATs can have independent locations or can be made as part of hotels. Making CATs as part of the hotels will make the transportation companies, travelers and hotels work in a synergistic manner where each benefits the other. For the transportation company, they need not have the responsibility of owning and maintaining CATs in separate locations; having CATs in hotels will be convenient for travelers for overnight stay and during stop over; and the hotels will get increased exposure and visibility from travelers who are most likely to stay in the hotels where CATs are located.

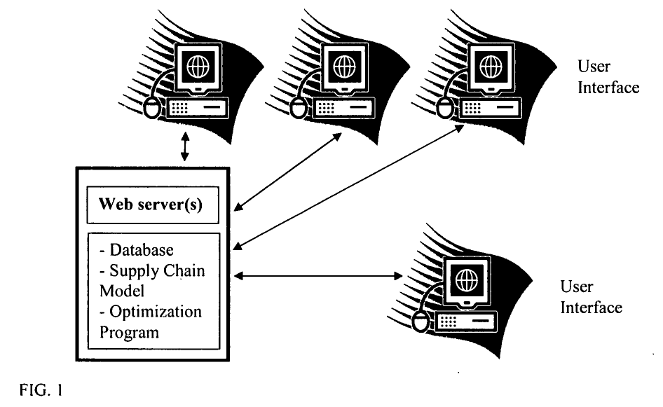

Adverting now to the drawings, FIG. 1 is a schematic diagram of different components involved in creating an integrated web site of the present invention. The overall web site includes four components: user interface (UI) screens, supply chain model, database to hold all information regarding customer, vehicle availability, etc. and a background model and supply chain type optimization search program to match the customer requirement and vehicle availability. FIG. 1 shows a schematic of the different components and the interaction between them.

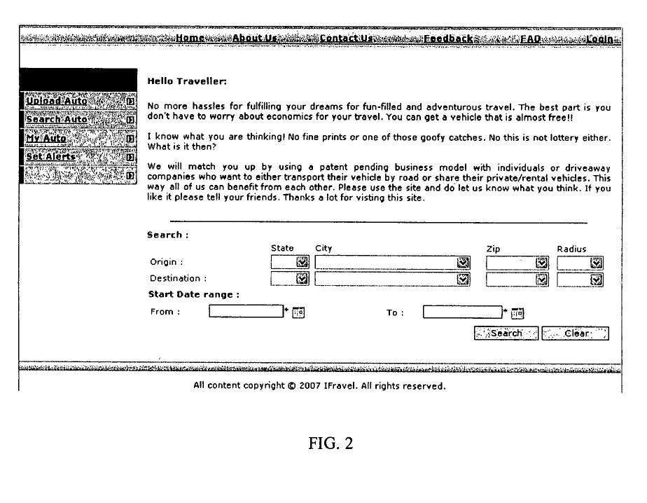

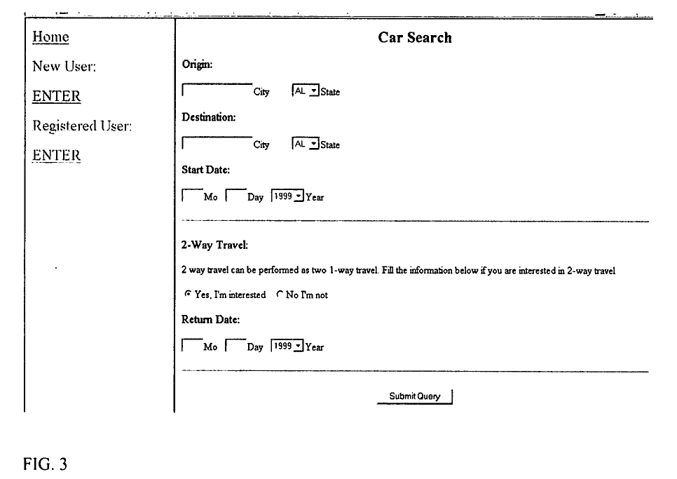

FIG. 2 depicts a sample web page start screen for user interface. The user interface consists of different screens including a registration screen for the new user, search screens for a user to find automobiles and screens for automobile moving companies to list their available automobiles. Some sample screens are shown in FIG. 2 and FIG. 3 and are presented here for illustrative purposes and these embodiments are two of many possible embodiments. It is contemplated as part of the present invention that to accommodate various user needs, different screens than shown in the figures referred to herein will be provided, such as screens having different interactive sections designed for better user appeal.

FIG. 3 depicts a sample search screen for registered user of a preferred embodiment of the present invention. After logging in using the log in screen, the user will be provided options to search for automobiles available for desired departure and destination locations for specific dates for a specified number of passengers. If a vehicle cannot be found for options specified by the user, other options will be provided to search for the closest available date and locations for the vehicle. The user has the option of providing the date range and radial distance range from origin as well as destination location to search for. If the user is unable to find an automobile using the above options, then the user can use an advanced search pattern. The advanced search involves stop and change over of automobiles in intermediate locations between the departure and destination locations. The user can limit the number of stop overs and also specify whether or not it can involve more than one automobile moving company. The stop over can occur at different automobile companies, at intermediate locations mutually agreed by different drivers of the automobile and the supplier of the automobile, or at one of the Centralized Auto Terminal (CAT) location proposed in the supply chain model section of this document. The user can also specify the total miles he or she is willing to drive for-the whole trip including the stop over locations. Based on the options specified by the driver/user, an optimization program running as a background program in a web server will determine the best option for the user and display the results.

If the first driver/user is unable to find an automobile using the basic or the advanced search option, he or she can try the car pool option. The program will search for other driver/user (second and third driver/user, etc.) with an automobile booking whose trip encompasses the searcher's trip itinerary and is willing to car pool with other persons. If such a second driver/user with an automobile booking is found, the result will be displayed to the first user (only the automobile details will be displayed. No information about the second driver/user will be shown). The vehicle supplier information will also be provided to the first user. If first user presses the “book it” button, an email will be sent to second and third user, etc. and vehicle supplier indicating that first driver/user wants to car pool with second and third user, etc. who will be given first user's contact information (for example phone number and/or email) to contact first user within a specified time. A communication, such as an email come on will also be sent to the first user with the message that second and third user, etc. is willing to car pool and will contact first driver/user within a specified time frame. Vehicle supplier will contact all driver/user to provide consent for the car pool.

The program will also search for the best deals for “paid” auto rentals from different auto rental companies and/or travel sites and display the results along with the free auto rentals from the search above. The users then decide and compare the different options with respect to pricing, ease of travel, type of available automobile, etc. to make their final decision about the automobile rental. In a broader perspective the search could also include public ground transportation such as greyhound bus services, train services, etc. Two kinds of data validations as will be performed: Front end user interface data validation: The user interface program checks for non-empty data in required fields and will also make sure the entered data is in proper format (such as email address etc.). This validation will be performed by the code within the user interface itself before the data is passed on to the database. If the data entered by the user passes the front end validation, the data will be passed to the database. Here further validation of the data (for example, uniqueness of user id, etc.) will be performed and the results will be returned to the user interface (either error message or if successful to the next step).

The individual supplier will be asked to deposit a small fee by credit card through a secure site when he or she uploads vehicle availability information in the database. This amount will be refunded when the supplier gets a customer for driving the vehicle or if the supplier removes the vehicle availability from the system.

When the customer presses the “Book it” button to book an automobile, he or she will be asked to provide a credit card number through a secure site. The customer will be informed that if the booking goes through and is confirmed with the supplier a nominal booking fee will be charged to the credit card. Also, a deposit amount will be taken. This booking fee and deposit amount will be refunded if the transaction gets cancelled. The deposit fee will be returned after successful vehicle delivery. The customer will also be given a password to provide to the auto supplier after the supplier hands over the automobile to the customer to confirm the auto transaction. The supplier can go to the web site and type in the password to get back his or her deposit amount.

When the vehicle availability is confirmed to the customer, two passwords will be provided to the supplier: one if the supplier, for some reason, doesn't want to provide the vehicle to the customer and other password that the supplier will enter (or give to the customer) after successful vehicle delivery. If the first password is entered in the web site by the customer, then it would indicate a vehicle transaction cancellation and the customer will be refunded their booking fee. The second password is entered in the web site to mark the completion of the auto delivery to the supplier at the destination point. This will usually be done by the supplier immediately after the vehicle delivery. This process will initiate the customer security deposit refund process. After the second password is entered by the supplier, the web site will prompt for the amount to be refunded to the customer (maximum equal to the deposit amount paid by the customer). This amount will be refunded to the customer. The entire deposit fee will be returned if there are no damages to the vehicle caused by the customer. If there are damages to the vehicle, as agreed by the supplier and customer, the deposit amount less the amount needed to fix the damages will be returned to the customer. If the amount needed to fix the damages is more than the deposit amount, then the deposit will be forfeited. The supplier will be given the deposit amount forfeited by the customer to pay for damages or deductible of vehicle insurance to fix the vehicle damages.

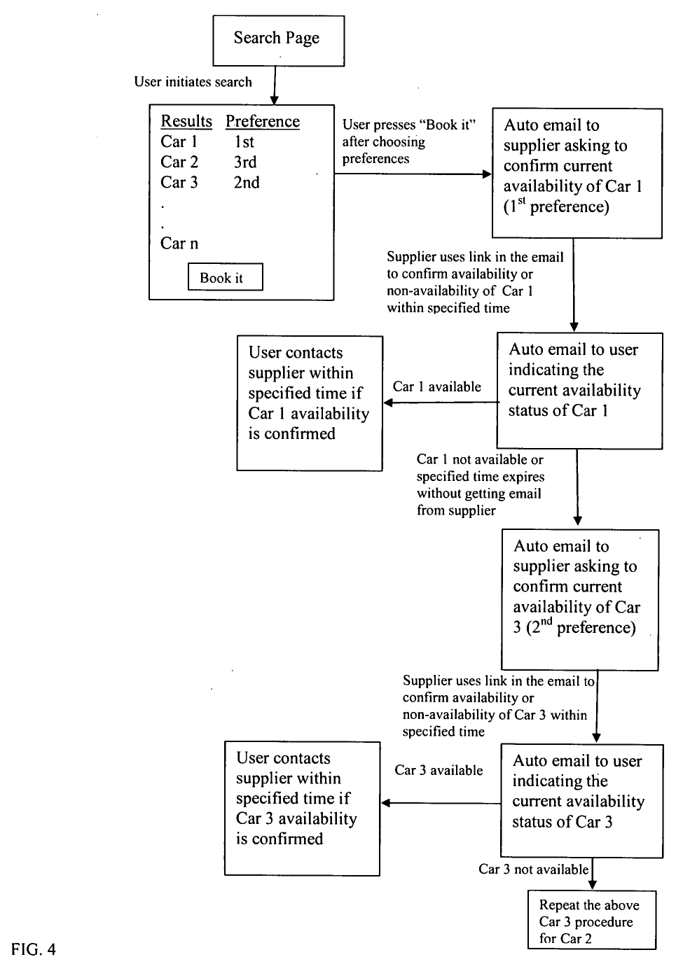

FIG. 4 depicts a schematic showing the functionality of the Auto Acceptance Alert system. A preferred embodiment of the present invention has the following alerts in the system: Auto Acceptance Alert that is used for booking an automobile from results of basic, advanced or car pool search. When an automobile meeting the user's search criteria is available, he or she can choose up to 3 automobiles and list the preferred choice by using the numbers 1, 2 and 3 (1 being the most preferred). The user then clicks the “book it” button from the search results page. When this button is pressed a pop up message box appears informing the user that an email will be sent to him or her within a specified time after confirming the current availability of the automobile with the supplier(s). An auto email will be sent to the supplier of the user's 1st preference automobile indicating the availability of a qualified driver for the automobile and asking the supplier to confirm the current availability of the vehicle within a specified time. Once the confirmation is received from the supplier or the specified time expires, an alert email will be sent to the user (who booked the automobile) regarding the availability (or non-availability) of the automobile (based on the supplier's confirmation email). If the supplier had confirmed the availability, the alert email sent to the user will have the supplier contact information for the user to contact the supplier and make further arrangements regarding the vehicle transportation. If the supplier had indicated a non-availability of automobile or the specified time expired without getting an email from the supplier, then an auto email will be sent to the supplier of the user's 2nd preference to confirm the availability of the automobile.

If there is no automobile meeting the users search criteria is available, a check box option (User Search Criteria Met Alert) will be provided to the user to alert when an automobile meeting his or her criteria becomes available. If the user checks the check box, then the system will continuously monitor the criteria and send an alert email to the user when the criteria is met. When the user creates a user profile an option will be provided to send a weekly alert email listing the available automobile from his home city (Home Location Auto Availability Alert). If the user checks the box, an email will be sent weekly (preferably Wednesday or Thursday) listing the available automobiles. The default option of the check box is “not checked”. An alerts page will be provided (General Interest Alert) where a user can enter the origin and destination location(s). The user may or may not enter a date range. He or she can then click the “Alert Me” button to receive alerts when an automobile is available from his or her origin(s) to destination(s). The background program will monitor this alert condition and send alerts when an automobile meeting the desired search criteria is available. The supplier of automobiles can be companies such as drive away companies, auto dealerships, trucking companies, etc. or individuals who want to move their automobiles. There will be separate login and displays built for suppliers (Supplier's Pages). The companies and individuals can enter their vehicle availability information including dates and locations. In addition the companies can also list their intermediate locations and which locations can be used as stop or change over locations. The individual suppliers will have also have the option of specifying whether they want a single person to move their car the entire way or whether multiple people can be involved in the moving. It will be the supplier's responsibility to verify the renter's information background, insurance, etc. The web site will provide guidance as to how to verify the user's identity and can also facilitate such a transaction. The web site owners, however, will not be responsible for the quality or nature of the renter. The supplier's can specify additional information such as the maximum mileage that can be put in the vehicle between the start and destination locations, etc. The supplier's page can be used to list the vehicles information such as type, make, model, year, # of passengers allowed, etc. When a supplier enters the available vehicle information, the alerts table(s) is immediately searched for users matching the automobile information entered by the supplier. If no user is found, then multiple users are searched with possible intermediate locations for vehicle transfer. If such user(s) are found, alert(s) is/are immediately sent to indicate the availability of an automobile matching the user's interest. The alert system can also be made to run as a scheduled task at prescribed time intervals to check and send emails or notifications.

The server database will have several tables to hold all the user profile information, vehicle supplier information, vehicle information, origin and destination information, CAT locations, mileage calculation information (to calculate distance from one location to another) and all other information related to the operation of the web site. The database is a relational database, object oriented database, or any other database that is determined appropriate for holding and querying the information from the database. The database will also have event based triggers that executes specific tasks such as sending an email when an alert occurs, etc.

The supply chain model will utilize the information provided by the automobile suppliers to relate several start and destination locations along with possible intermediate locations. The intermediate locations can be any one of the following: drive away or any other auto supplier location at an intermediate location, any intermediate locations specified by the user in search criteria or in the alerts request created, at Centralized Auto Terminals (CAT) that can be created as discussed below in the next sub section. The intermediate location, for example, can also be a friend or relative's location of the supplier. In that case the supplier can generate a password for each user and provide it to the users of the vehicle that will be involved in the intermediate location. The supplier can provide the password(s) to his or her friend or relative. The friend or relative at the intermediate location can verify the password(s) in addition to the valid identification documents to complete the transaction of automobile/user switch over. The supply chain models will also have all the necessary information about the intermediate locations (such as hours of operation, size of location, average number of automobiles available in the location, etc. The overall supply chain model will use a standardized distance chart table available from a reputable software package to relate different locations origin/destination locations with the intermediate locations. In addition to searching for vehicles that have been booked for auto pooling, the web site will also provide the facility for the user to search for private vehicle owners who are traveling and willing to share their vehicle with other people. The private vehicles can be of any type: automobiles, private jets, boats, etc. Thus the web site will serve as one common platform for free rentals and vehicle sharing.

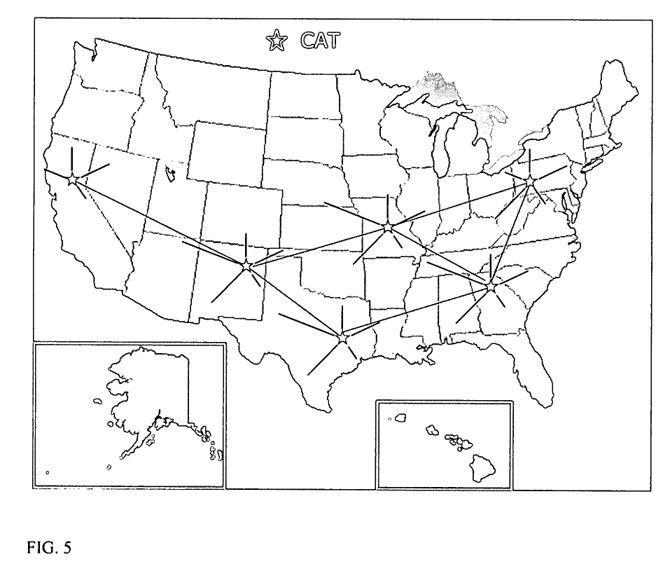

FIG. 5 shows a schematic of the Centralized Auto Terminal (CATs) as part of distribution network. The Centralized Auto Terminal is a stop or change over locations at strategic cities in order to facilitate the movement of vehicle between several start and destination locations. CATs will provide a convenient intermediate place where people can exchange cars and continue their journey. In short the CATs will serve as nodes for a distribution network of the automobiles being transported from one location to other across the nation. The CATs are owned and operated by individual companies or a consortium of companies (for example, a group of driveway companies). CATs have the facilities to scan incoming and outgoing vehicles, keep track of the vehicle exchanges and the personnel involved in the transaction. CATs are also at Hotel locations whereby certain locations in the Hotel's parking lots are allotted to CAT users. The hotels benefit from increased visibility and access to CAT users. CAT users will stay in the hotels that have the CATs and hence the hotels and CATs mutually benefit.

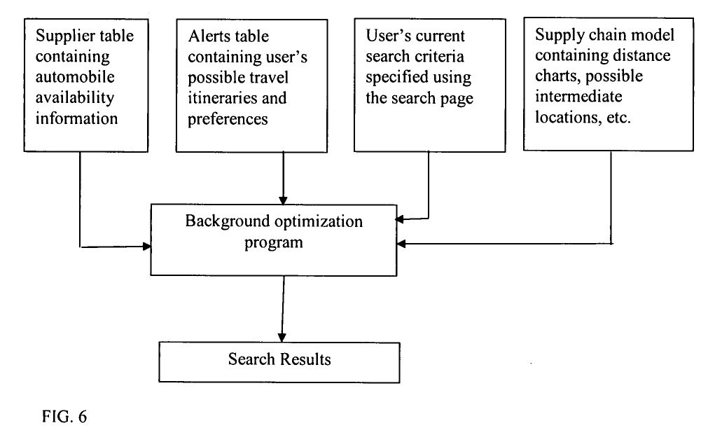

FIG. 6 depicts a flow chart showing the operation of background optimization program. A background optimization program containing integer and continuous variables is run for the advanced search criteria specified by the user using the information from supplier's table, alerts table, supply chain model and user search page to find the best automobile available by minimizing the number of stop over, distance traveled between departure and destination locations, or any other appropriate optimization objective as shown in FIG. 6. The optimization program imposes constraints with regard to any preferred intermediate location(s) of the user, start dates, etc. Thus the user is expected to provide start date(s), arrival date(s), intermediate locations preferred (if any), number of stop overs, number of automobile companies involved, etc. for the optimizer to find the best possible solution to meet the customer preferences. If all constraints cannot be satisfied, the optimizer will provide a feasible solution by relaxing some of the user constraints. Revenue from the web site is derived from the following sources: revenue generated from advertisements that are posted in the web site, subscription charges to use the web site (from suppliers of automobiles who need to find drivers to move their cars), transaction charges from customers. If the CATs are located at hotels, then it is expected that hotels will advertise on the web site and the hotels will be charged a subscription fee.

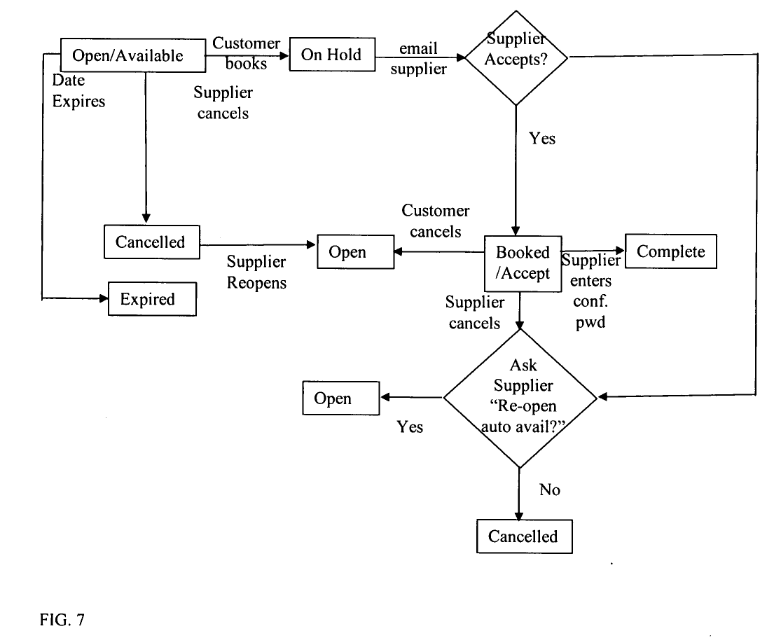

FIG. 7: Flow chart for vehicle status change during the course of booking and vehicle transportation. The program updates the status on the transaction table when an email is sent to the customer (change “available” to “awaiting”) status and load the status as “available” (default) when the supplier is uploading the vehicle. The drivers/user has the option to check “do not do business with” table before displaying results for the customer and before sending email to supplier. The website displays the rating when the results are displayed for the customer (supplier rating) and when confirmation email is sent to supplier (customer rating). Customer and user rating can be done only when a transaction occurs between the specific supplier and customer (In other words everybody cannot rate everyone else). The program archives older postings and completed transactions. If supplier does not respond in a specific period (say 24 hours), the system sends an email automatically to the customer cancelling their transaction. A user cannot cancel a completed transaction if the date has passed already. When supplier cancels, an option to reupload with different dates of availability.

Thus, the invention as described above aims to develop a fundamental business model and web site to bring together companies transporting vehicles, travelers looking for a bargain deal for their travel and hotels trying to increase their occupancy rate with increased exposure to travelers. It is seen that the objects of the invention are efficiently obtained. It will be understood that the foregoing description is illustrative of the invention and should not be considered as limiting and that other embodiments of the invention are possible without departing from the invention's spirit and scope.

What is claimed is:

1. A vehicle transportation system, comprising: (a) gathering vehicle information regarding vehicle availability and vehicle destination from a vehicle supplier interested in transporting vehicles from a first location to a second location and traveler information regarding travelers interested in driving or riding in said vehicles from said first location to said second location; (b) storing said vehicle information and said traveler information into a centralized computer; (c) controlling said information through an integrated framework programmed to match said vehicle with said travelers to drive said vehicle from said first location to said second location; (d) making said vehicle availability information and vehicle destination information accessible via web page on the internet; (e) utilizing a “supply chain” model to optimize the distance traveled, the number of vehicle and traveler change overs and the time spent in between change overs; and (d) providing centralized auto terminals to allow for vehicle and traveler exchanges.

2. A vehicle transportation system, according to claim 1, wherein said traveler does not incur daily rental charges or drop-off charges for said vehicle.

3. A vehicle transportation system, according to claim 1, wherein said vehicle supplier is a drive away company.

4. A vehicle transportation system, according to claim 1, wherein said vehicle supplier is a rental car company.

5. A vehicle transportation system, according to claim 1, wherein said vehicle supplier is a trucking company.

6. A vehicle transportation system, according to claim 1, wherein said vehicle supplier is an individual.

7. A vehicle transportation system, according to claim 1 wherein said computer controlled integrated framework is programmed to serve as a common platform where said travelers with common source and destination will be able to contact each other to share a paid transportation.

8. A vehicle transportation system, according to claim 7 wherein said paid transportation is a rental car.

10. A vehicle transportation system, according to claim 1, wherein: said computer controlled integrated framework includes a means for receiving a request from said traveler and communicate to said vehicle supplier to confirm status of said vehicle.

11. A vehicle transportation system, according to claim 10, wherein said computer controlled integrated framework includes means for detecting said status of said vehicle as one of the following: Open, On Hold, Booked, Cancelled or Complete.

12. A vehicle transportation system, according to claim 1, wherein said computer controlled integrated framework includes a means for detecting a plurality of travelers at said first location and is adapted to match said travelers in a carpool.

13. A vehicle transportation system, according to claim 1, wherein said vehicle supplier is an auto dealership.

14. A vehicle transportation system, according to claim 1, wherein said vehicles include road, air and water transportation vehicles.

15. A vehicle transportation system, according to claim 1, wherein said computer controlled integrated framework includes a means for detecting a plurality of travelers at said first location and is adapted to match said travelers in a carpool.

16. A vehicle transportation system, according to claim 1, wherein said centralized auto terminals are linked with hotels at intermediate transfer locations.
